(19) United States
(12) Patent Application Publication
(10) Pub. No.: US 2022/0341403 A1
(43) Pub. Date: Oct. 27, 2022

(54) STEEL MICROFIBER HEATING ELEMENT FOR SOFT ACTUATION AND METHOD

(71) Applicant: KING ABDULLAH UNIVERSITY OF SCIENCE AND TECHNOLOGY, Thuwal (SA)

(72) Inventors: Ragesh CHELLATTOAN, Thuwal (SA); Gilles LUBINEAU, Thuwal (SA); Arief YUDHANTO, Thuwal (SA)

(21) Appl. No.: 17/620,808

(22) PCT Filed: Jun. 24, 2020
(86) PCT No.: PCT/IB2020/055987

§ 371 Date: Dec. 20, 2021

Related U.S. Application Data
(60) Provisional application No. 62/870,138, filed on Jul. 3, 2019.

(51) Int. Cl. F03G 7/06; H05B 3/34; A41D 31/04

(52) U.S. Cl. CPC F03G 7/06; H05B 3/342; A41D 31/04; A41D 2400/80; H05B 2203/034; H05B 2203/036; H05B 2203/017

(57) ABSTRACT

A heating element includes first and second blocks made of microfibers of steel, each block having an electrical input and an electrical output, and an electrical connection that connects an electrical output of the first block to an electrical input of the second block. The microfibers have a diameter between 10 and 30 micrometers.

### CROSS-REFERENCE TO RELATED APPLICATIONS

This application claims priority to U.S. Provisional Patent Application No. 62/870,138, filed on Jul. 3, 2019, entitled “POROUS, FLEXIBLE AND HIGH PERFORMING 3-D HEATING ELEMENT FROM MICRO FIBERS OF STEEL,” the disclosure of which is incorporated herein by reference in its entirety.

### BACKGROUND

### Technical Field

Embodiments of the subject matter disclosed herein generally relate to a system and method for actuating a given element, and more particularly, to a soft robotic device that uses the given element as a flexible body.

### Discussion of the Background

There is a desire to develop robots that use not only rigid parts, but also soft parts, to mimic the human body. In this respect, heating elements used in soft robotic applications employ a variety of flexible materials such a metallic nanowire, and carbon nanotube. However, each of these applications has a poor performance under strain. For example, these applications have a low strain (less than 10%) and also require a high voltage (over 1 KV) for being actuated.

Various technologies have been considered for developing a flexible and porous heating element. Such heating element includes, but is not limited to, porous metal foam, porous carbon nanotube (CNT)-polymer composite, and silver nanowire (AgNWs)-polymer sponge. Although some metal foam has a large surface-to-volume ratio and good heating property, it is not flexible because of its high bending stiffness. The CNT-polymer sponge is flexible and stretchable, but it possesses a high resistance, usually in the order of kΩ because of the tunneling resistance at the inter-particle junctions. Thus, the CNT-polymer composite requires a too high voltage for generating sufficient Joule heating. The detrimental effect of contact resistance in the CNT network could be overcome by using high-aspect ratio silver nanowires, but the diameter of the individual nanowire is only 50-100 nm. Silver nanowires were easily melted even at a low current (usually in the range of mA). Moreover, due to the high-piezoresistivity in percolation-based nanomaterials, the resistance in both CNT and silver nanowires based conductive polymers may significantly vary during deformation. This is not desired for a constant resistance system that operates at constant input power and for controlling the heat input.

A more recent development in soft robotics, called thermofluidic actuation, is based on the phase transition of a selected liquid [1]. The thermofluidic actuation uses an elastomeric matrix with an embedded liquid. An external power source supplies electrical current to a heating element, which is also embedded into the elastomeric matrix, for evaporating the embedded liquid. By transforming the liquid into a gas, the elastomeric matrix is capable of changing its shape, as desired by the user. Thus, the thermofluidic actuation process requires a porous and flexible three-dimensional (3D) heating element to distribute the heat uniformly in the deformable elastomeric structure, to improve the actuation speed. However, a cheap, porous, and flexible 3D heating element is still missing.

Thus, there is a need for a novel heating element that is cheap, easy to manufacture, flexible, and porous so that a phase change of the liquid stored in the elastomeric structure is quickly achieved.

### BRIEF SUMMARY OF THE INVENTION

According to an embodiment, there is a heating element that includes first and second blocks made of microfibers of steel, each block having an electrical input and an electrical output, and an electrical connection that connects an electrical output of the first block to an electrical input of the second block. The microfibers have a diameter between 10 and 30 micrometers.

According to another embodiment, there is a soft actuator that includes a housing having plural chambers, a base attached to the housing to seal the chambers, a heating element located inside the housing and extending through the plural chambers, and a liquid filling each chamber of the plural chambers. The heating element is made of microfibers of steel.

According to yet another embodiment, there is an article of clothing having an external surface with an adjustable roughness. The article of clothing includes a substrate material from which the article of clothing is made, and a soft actuator formed on the external surface of the substrate material. The soft actuator changes the roughness of the external surface of the substrate material by changing a phase of a liquid stored in the soft actuator, by using electrical energy.

### BRIEF DESCRIPTION OF THE DRAWINGS

For a more complete understanding of the present invention, reference is now made to the following descriptions taken in conjunction with the accompanying drawings, in which:

FIG. 1 is a schematic illustration of a yarn made with microfibers of steel;

FIG. 2A illustrates a three-dimensional heating element made with microfibers of steel, FIG. 2B illustrates a first implementation of the heating element while FIG. 2C illustrates a different, second implementation of the heating element;

FIG. 3 illustrates various grades of steel microfibers;

FIG. 4 illustrates the resistance of the various grades of steel microfibers;

FIG. 5 is a microscopic image of the yarn of steel microfibers and the pores formed within;

FIG. 6 illustrates a current versus voltage curve for the yarn made of steel microfibers;

FIGS. 7A and 7B illustrate the resistance of the yarn made of steel microfibers when subjected to compression and bending;

FIGS. 8A and 8B illustrate the temperature versus time response of the yarn made of steel microfibers;

FIGS. 9A and 9B illustrate an implementation of the heating element of FIG. 2A into a soft actuator;

FIGS. 10A and 10B illustrate various steps of making the soft actuator with the heating element of FIG. 2A;

FIGS. 11A to 110 illustrate the response of the soft actuator when electrical power is applied to vaporize a liquid inside the soft actuator;

FIGS. 12A and 12B illustrate an implementation of the soft actuator into a garment and FIGS. 12C and 12D illustrate another implementation of the soft actuator into the garment; and

FIG. 13 is a flowchart of a method for adjusting a roughness of an external surface of the garment article.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a soft actuator that includes a yarn of steel microfibers distributed through plural chambers that deform asymmetrically. However, the embodiments to be discussed next are not limited to such a system, but may be applied to other actuators or article of clothing.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a porous and flexible heating element is fabricated from low-cost steel microfibers. The resistance of the fabricated yarn from the steel microfibers may be about 0.5 ohm per centimeter. The resistance can be further tuned by varying the diameter of the yarn. Upon the application of a voltage to the steel microfibers, heat is generated, so that a liquid located in the pores formed by the steel microfibers experience a phase change, thus, increasing its volume. This change in volume is used to change a shape of a material in which the steel microfibers are housed. The change in volume makes the material to act as an actuator. This novel actuator is useful for a wide range of flexible applications, including, but not limited to, soft robotic applications, heated gloves and fabrics, etc.

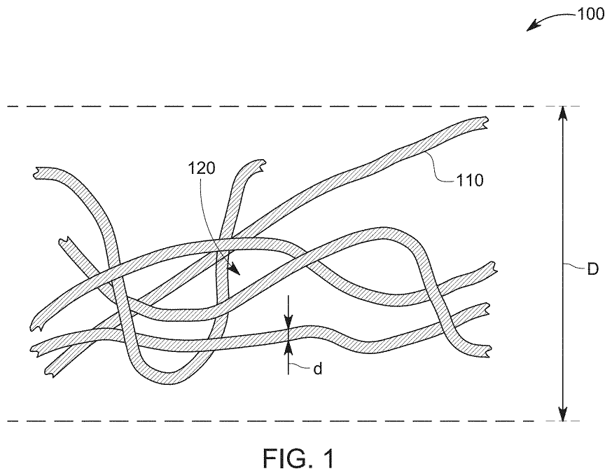

The steel microfibers are made into a steel wool yarn 100, as shown in FIG. 1, that contains a random network of numerous steel microfibers 110 with the individual diameter in the range of 5 to 100 microns, or 10 to 30 microns, with a preferred diameter about 25 microns. These loosely connected microfibers 110 make the structure/yarn 100 porous and highly flexible to accommodate a large deformation. The steel wool yarn 100 is shown in FIG. 1 having plural pores 120. These pores would accommodate a liquid that is expected to change its phase when an electrical current is supplied to the yarn. Because of the small size of the steel microfibers 110, the pores 120 defined by these microfibers will have a small volume, which means that the liquid is divided into small volumes inside the yarn 100. This configuration promotes the phase change of the liquid when the steel microfibers are activated with an electrical current, as the joule heat generated be the steel microfibers would quickly boil the small pockets of the liquid. In this regard, the fabricated steel yarn 100 has a good current carrying capacity (up to 0.25 A/mm²) compared to the Ag NWs. Compared to CNT, the resistance of the steel wool can be tuned by choosing both the diameter D of the yarn 100 and the diameter d of the fibers 110. Moreover, steel exhibits a low-thermal conductivity than other metals like aluminum and brass, providing a relatively high-heat transfer coefficient for the heating liquid (not shown). Additionally, the steel wool is safe to handle and very economical compared to the nanomaterials.

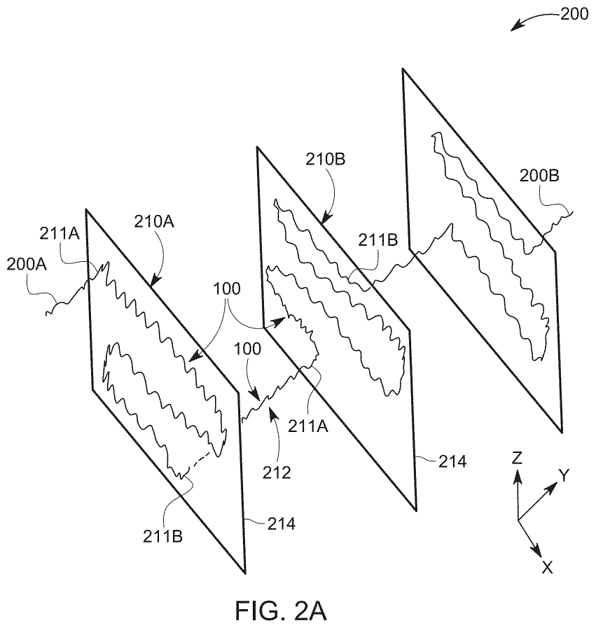

In one embodiment, as illustrated in FIG. 2A, a heating element 200 is fabricated from the steel wool, by manually twisting the thin fibers 110 and then compacting the thin fibers 110 of stainless steel to form the yarn 100. As discussed later, the heating element 200 can be inserted into a housing having various corrugated elements. To fit inside the plural corrugated elements, the steel yarn 100 is shaped to form plural blocks 210A, 210B of steel microfibers as shown in FIG. 2A. Each block is made of a single piece of yarn 100 that includes plural steel microfibers 110. Each block has a single electrical input 211A and a single electrical output 211B. The plural blocks are serially connected to each other with electrical connections 212, which are part of the same steel yarn 100, to form the 3D heating element 200. In this way, the 3D heating element 200 has a first end 200A and a second end 200B. The two ends 200A and 200B can be connected to a power source, for example, a battery, for receiving the electrical energy necessary to change the phase of the liquid stored in the corrugated elements.

Note that in the embodiment illustrated in FIG. 2A, each block extends in a XZ plane, while the electrical connections 212 extend along the Y axis, between the blocks. However, the blocks may extend in other planes as long as the entire structure is a 3D structure. In one application, the entire structure 200 is a 2D structure, i.e., both the blocks and the electrical connections extend in the same plane. While the blocks 210A and 210B are shown in FIG. 2A as having a rectangular profile, other profiles (triangle, rhombic, square, etc.) may be used. In one embodiment, the blocks 210A, 210B are not physical elements that support the yarn 100, but rather the strands of the yarn, when manufactured as shown in FIG. 2A, extend along a plane, which is called the blocks 210A, 210B. In other words, it is possible to arrange the yarn 100 to form a sponge like structure, which is the block 210A, as shown in FIG. 2B. However, in another embodiment, the yarn 100 is shaped as in FIG. 2C and attached to plural substrates 214, that form the blocks 210A, 210B, and the plural substrates 214 are made, for example, of an insulator material. Thus, the difference between the configurations in FIGS. 2B and 2C is that the yarn 100 in FIG. 2B forms the block 210A while the yarn in FIG. 2C is attached to a substrate and the substrate and the yarn form the block 210A.

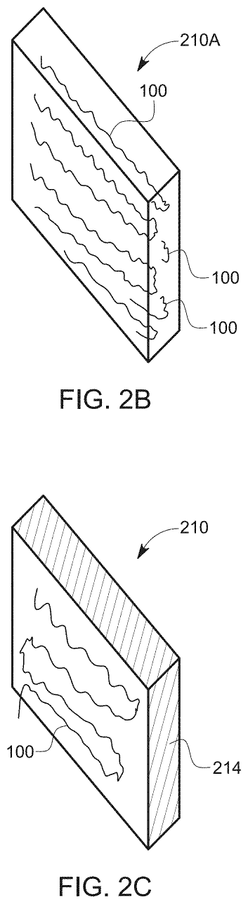

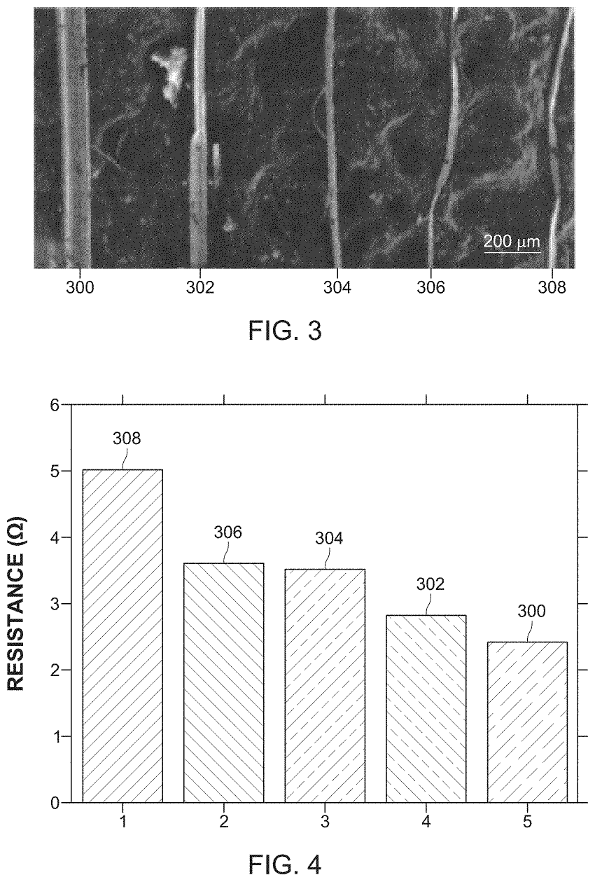

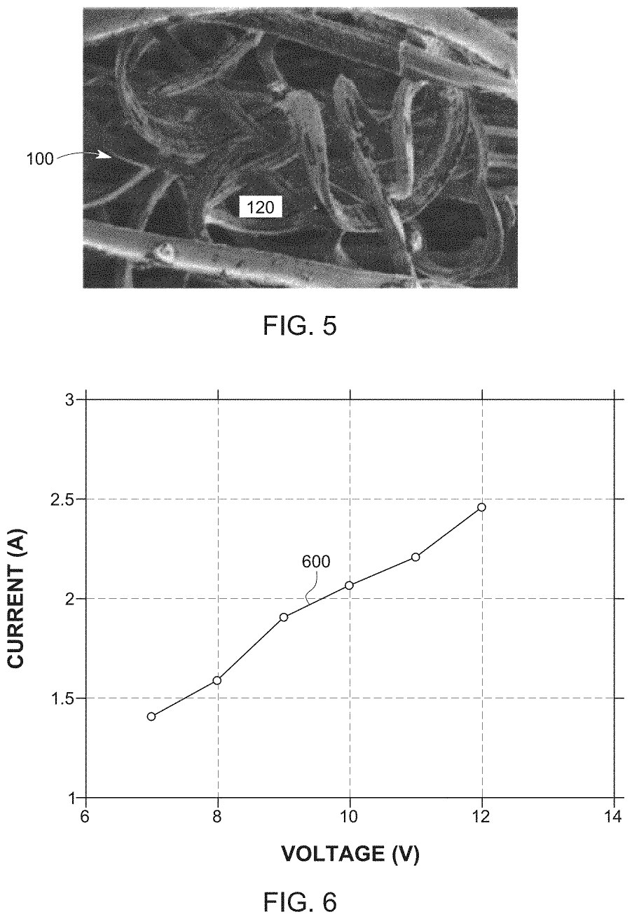

Five different grades of steel wool were used for making different heating elements 200 in an effort to determine which one is more appropriate for soft robotic applications. The five grades are known in the art as the Grade-0 to Grade-00000. The grade indicates the approximate diameter of the steel wool fiber 110 and the five grades as shown in FIG. 3, where fiber 300 corresponds to Grade-0, fiber 302 corresponds to Grade-00, fiber 304 corresponds to Grade-000, fiber 306 corresponds to Grade-0000, and fiber 308 corresponds to Grade-00000. For example, Grade-0 characterizes fibers with a diameter more than 100 μm whereas Grade-00000 characterizes fibers with a diameter of about 25 μm. The size of the diameter of the fibers has a direct influence on the resistance value R=ρL/A, where R is the resistance, ρ is the resistivity, L is the length of the fiber, and A is the cross section area of the fiber. For example, if the diameter of the fiber 110 decreases, its resistance value increases. This is also reflected in the evaluation of the resistance of steel wool yarn 100. In this regard, the resistance of the yarn 100 having a length L=100 mm and a diameter d=2 mm, when made out of one of the 5 grades of steel wool illustrated in FIG. 3, is measured using a 2-probe resistance measuring device and the results are shown in FIG. 4. The Grade-00000 fiber 308 is selected in the next embodiments for making the heating element 200, due to its elevated resistance compared to other grades, which is useful when dissipating the input electrical energy into heat, for changing the phase of the liquid. The yarn fabricated from Grade-00000 fibers 308 has a resistance value of about 4.850. The SEM image of steel wool yarn 100 made of the Grade-00000 fibers 308 is shown in FIG. 5 and reflects the fact that the steel wool yarn 100, even after the compaction process, is porous (see pores 120 in the figure) in nature.

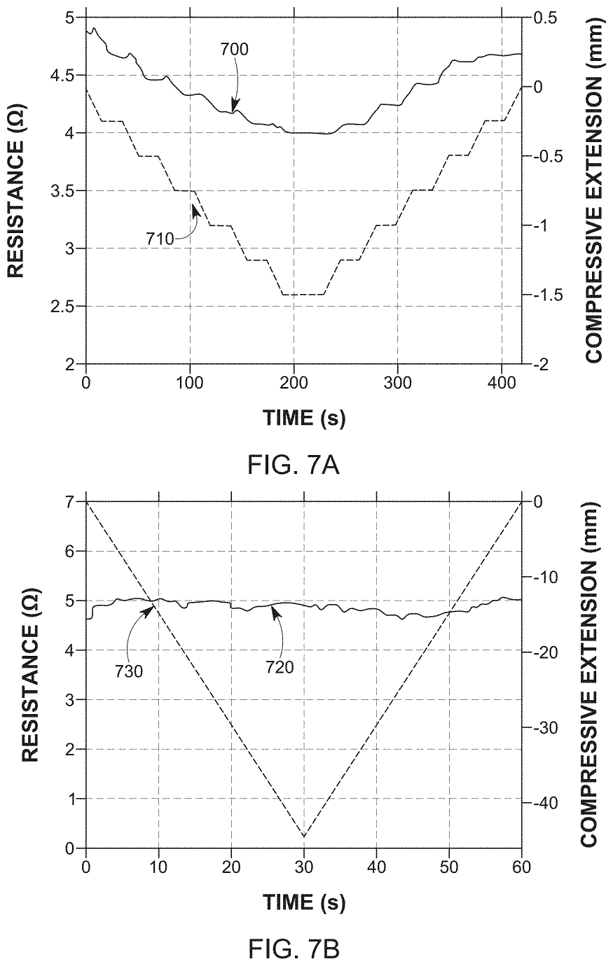

The steel wool yarn 100 also needs, in addition to the high resistance value, to be stable under an electrical load. In this respect, the electrical stability of the fabricated yarn 100 under Joule heating was measured. For this, an electric current ranging from 1.4 A to 2.46 A was passed through the heating element 200 by increasing the voltage step by step, and the results are shown in FIG. 6. The graph in FIG. 6 shows a stable increase in the current as the voltage increased and the change in resistance (the slope of the curve 600 in FIG. 6) of the heater is negligible. The resistance value does not change due to welding/melting of steel fibers during Joule heating. This illustrates that, due to the high-current carrying capacity of the steel microfibers 110 when compared to the metallic nanowires, such as silver nanowire, the steel wool fibers are more electrically stable during the heat generation process. It is worth noting that in a network of silver nanowires, the junction can get easily welded even at a small current (mA) due to its smaller dimension. This can lead to a significant change in the resistance value or even the destruction of the network. Similarly, in carbon-based materials, the resistance depends on the change in temperature and thus, the heating performance is negatively impacted by this characteristic. For these reasons, the steel wool yarn 100 shows better features than the existing materials used for the heating element in the soft robotic applications.

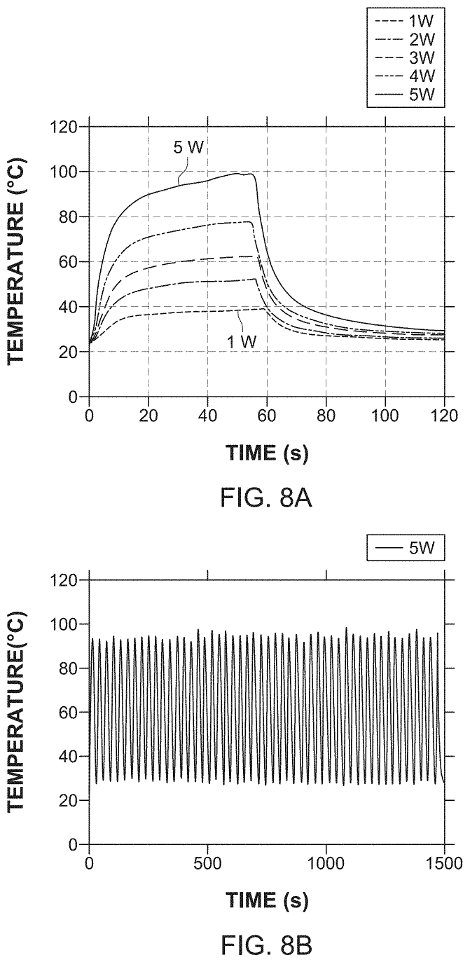

The steel wool yarn 100 further needs, in addition to the high resistance value and the high electrical load stability, to also show a stability under a mechanical load. To ensure that the compaction process when fabricating the yarn 100 did not drastically change the global resistance of the yarn, a compression test was performed and the results are shown in FIG. 7A. As can be seen from the FIG. 7A, the resistance 700 of the sample yarn before compression was around 4.9 W. After compressing the steel wool to 75% of its diameter, as illustrated by curve 710, the final resistance of the yarn 100 was changed to approximately 4.1 W, see curve 700, which accounts for only 16% of its initial value. Because the resistance curve 700 is substantially unchanged for various compressions of the steel wool yarn, it means that the conductivity of the sample yarn is almost independent of the amount of pressure applied during the compaction process.

Another test performed on the yarn sample was a bending test to check the change in the global resistance of the sample under bending strain and the results are shown in FIG. 7B. This is important because, in most of the heating element based on nanomaterials, the conductivity decreases drastically under strain due to the modification in contact resistance, which means that the heating performance will also be reduced drastically. The resistance-time curve 720 for this test and the displacement-time curve 730 are shown in FIG. 7B. The fact that the resistance-time curve 720 remains substantially constant while the fibers are compressed indicate that the selected grade is insensitive to the bending strain in terms of resistance, which is desired for the heating element 200.

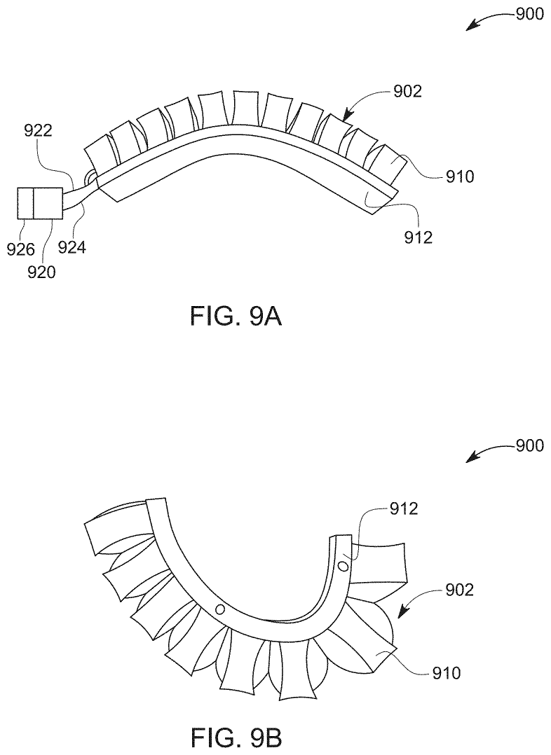

The steel wool yarn 100 has also been tested to check its heating performance as the steel wool yarn needs to quickly heat the liquid inside the soft robotic application. An electrical current was applied to the Grade-00000 yarn 100 with various input powers (from 1 to 5 W) and the corresponding rise in temperature was measured in open air. FIG. 8A shows that a stable temperature is achieved after 1 min. after injecting the current. Increasing the power from 1 to 5 W resulted in an increase in the average temperature from 40 to 100° C., as also shown in FIG. 8A. With the applied 5 W power, the temperature of the yarn 100 increased from the room temperature to 80° C. within 10 s, which indicate that the yarn 100 outperformed the recently reported other flexible heating elements made from nanomaterials [2, 3]. The Grade-00000 yarn 100 was also tested for cyclic heating-cooling by applying a maximum input power of 5 W for 1500 s. FIG. 8B shows that no degradation of temperature is observed over time when the input power is switched on and off, indicating a good heating-cooling performance.

The steel wool yarn 100 and the corresponding heating element 200, which is made from the steel wool yarn 100, have shown the following characteristics: (1) the material is porous, which is desires for thermofluidic soft robotics applications as the liquid that needs to be evaporated can be spread into the pores of the material and thus, a contact surface between the heating element and the liquid to be evaporated is maximized, (2) the material is flexible, which is beneficial as the heating element needs to conform with various objects, for example, the human body, and also needs to bend multiple times while performing its functionality, (3) the material is relative cheap and easy to manufacture, which is desired as the price of the robots needs to be reduced to be accessible to the large public, and (4) the material shows an optimum resistance, which means that it can release a large amount of Joule heat when a voltage is applied to its ends, resulting in a quick reaction time.

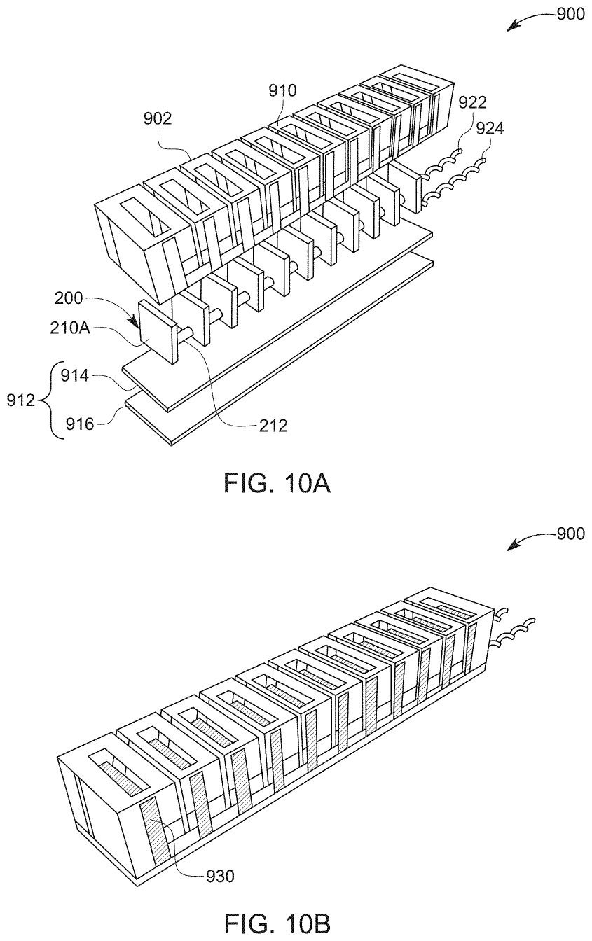

The above properties of the steel wool yarn 100 indicate that this material is most appropriate for functioning as an actuator for soft robotics applications. Thus, in one embodiment, a compliant soft structure capable of deforming under bending has been made with the steel wool yarn 100. The compliant soft structure is expected to be used for various soft robotic functionalities like walking, climbing, gripping, etc. In this embodiment, which is illustrated in FIG. 9A, the compliant soft actuator 900 (also called a soft actuator) includes a housing 902 that has a corrugated structure that includes plural chambers 910 formed on a base 912. The heating element 200 (not visible in FIG. 9A) is located inside the housing 902, so that a portion of the heating element is present in each chamber. The chambers are filled with a liquid that has a low evaporation temperature. When a voltage is applied from a power source 920, through electrical leads 922 and 924, the heat generated by the heating element 200 evaporates the liquid inside each chamber 902. The phase change from liquid to vapor makes the pressure in each chamber to increase. Because the base 912 is made of a material that is not as stretchable as the chambers 910, the chambers 910 tend to deform relative to the base 912, which results in an overall deformation of the compliant soft actuator 900, as shown in FIG. 9B. It is noted that the chambers 910 in FIG. 9B are swollen relative to the chambers 910 in FIG. 9A, indicating that the liquid inside the chambers has been partially or totally evaporated by the heating element.

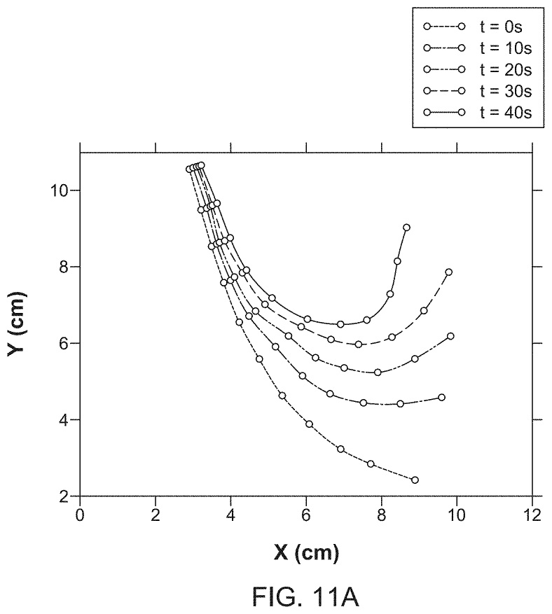

FIGS. 10A and 10B show in more detail the compliant soft actuator 900. FIG. 10A shows the housing 902 being made from a stretchable material, for example, silicon rubber, and having plural chambers 910. The heating element 200 is made of the steel wool yarn 100 and is connected with via the copper wires 922 and 924 to the electrical power source. The heating element 200 is placed so that each block 210A, 210B fits into a corresponding chamber 910. The bottom of the plural chambers 910 is attached to the base 912. The base 912 includes a stiff fabric layer 914, for example, cotton, which introduces the stiffness asymmetry needed for the bending, and a bottom flat layer 916, for example, silicon rubber. A liquid 930 (e.g., ethanol) fills each chamber 910 as shown in FIG. 10B. The bottom flat layer 916 is glued or attached by other means to the chambers 910, to seal the fluid and the heating element within the housing 902. When the power source 920 supplies the current to the steel wool yarn 100, it causes the heating element 200 to increase its temperature enough to vaporize the liquid 930 and create an internal pressure within the chambers. Due to the unsymmetrical structure of the housing imparted by the stiff layer 914, the soft actuator 900 deforms, which results in bending, as shown in FIG. 9B. A controller 926, which is shown in FIG. 9A, may be connected to the power source 920 to control when to apply the electrical current, for how long, and how large the current is. The controller 926 may include a wireless or wired communication device for receiving various commands regarding the soft actuator 900.

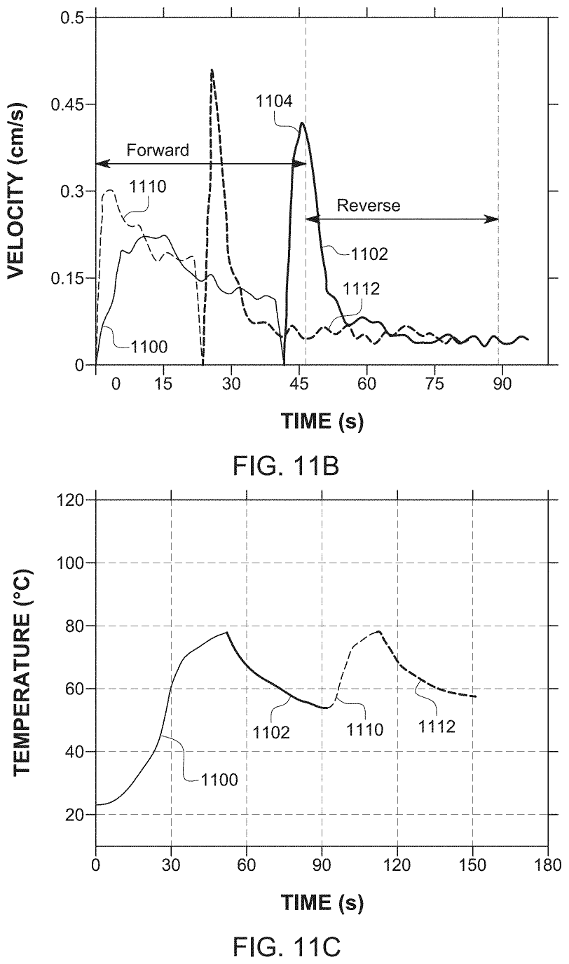

The response time of the compliant soft actuator 900 under thermal actuation is evaluated for an input energy of 30 W, by capturing the deformed shape using a video camera. The initial and deformed configurations under an input power of 30 W are shown in FIGS. 9A and 9B. The trajectory of the bending part of the soft actuator 900 is then evaluated at different time intervals on the captured video, as shown in FIG. 11A. During the forward actuation, which is illustrated in FIG. 11A, the soft actuator 900 produced a large motion for a low input power (30 W) in 40 s. This is a fast movement for such a large structure as the size of the structure in FIG. 9A is length l=110 mm, width w=20 mm, height h=20 mm, and weight is 42 g.

The velocity of the tip of the soft actuator 900 was evaluated to better understand the actuation speed, and the velocity for the forward movement and the backward movement of the tip is plotted in FIG. 11B. For the actuation speed measurement process, the inventors separated the situation corresponding to a pristine actuator (the actuator is cold and is going through its first cycle) and the situation of a preheated actuator (that is the typical situation during the second and following cycles). For the pristine condition, the velocity 1100 of the forward motion almost increased linearly in the first 10 s and then saturated at around 0.21 cm/s, followed by a slight decline. The velocity curve 1102 in reverse direction (40 s onwards) indicates, a sudden hike 1104 in the velocity in the first few seconds in the reverse direction, which then slowed down with time and decreased significantly at a later stage. In the subsequent cycle, in which the system is already preheated, it was found that the slope of the velocity graph 1110 increased sharply in the forward direction and the value of the maximum velocity has also increased to 0.31 cm/s (around 48%). The velocity curve 1112 for the reverse actuation is also increased slightly in the preheated system (from 0.42 cm/s to 0.51 cm/s), as illustrated in FIG. 11B.

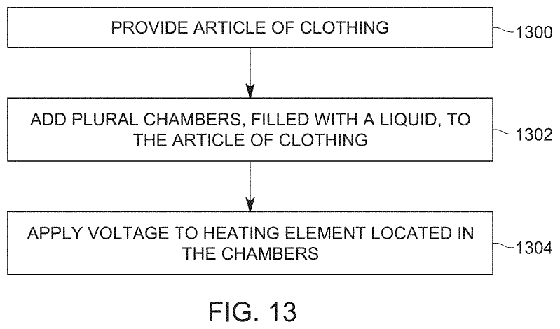

The increase in the reaction speed of the preheated system is explained by examining the temperature inside the housing 902, which is shown in FIG. 110. As illustrated in FIG. 110, the selected heating element 200 is good enough to generate the required temperature for actuation (around 78° C.) in a limited time. The analysis of the temperature in FIG. 11C shows that the temperature inside the housing of the pristine sample raised to 77° C. during the forward actuation and dropped to 54° C. before starting the next cycle. In the subsequent cycle, the steel wool yarn 100 could actuate the soft actuator 900 much faster due to the stored thermal energy in the previous cycle.

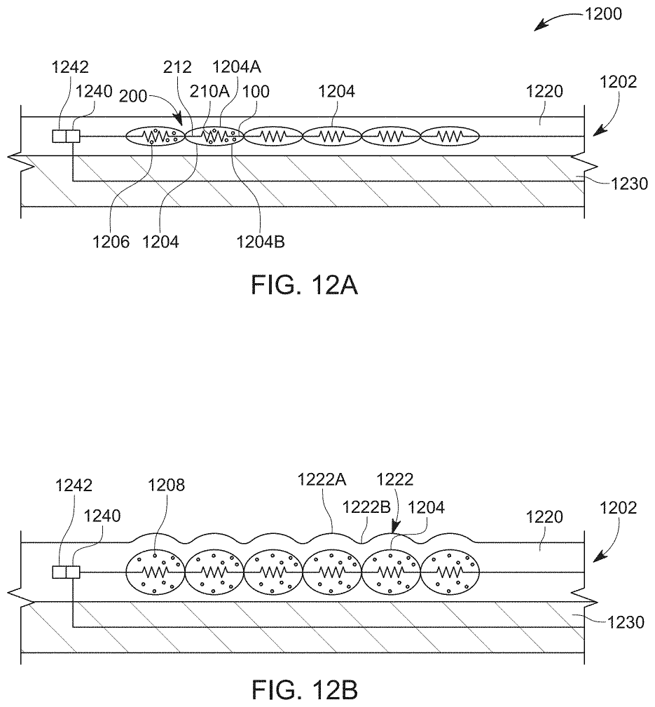

In another embodiment illustrated in FIGS. 12A and 12B, a soft actuator 1200 is implemented into a garment article 1202 and is used to change a shape of the surface of the garment article. In this embodiment, the garment article is a glove. However, those skilled in the art would understand that the garment article may be any other clothing article. The soft actuator 1200 includes plural chambers 1204 mechanically connected to each other. The plural chambers may also be fluidly connected to each other although this is not required. A top surface 1204A of a chamber 1204 is made of a stretchable material (for example, a silicone rubber) while a bottom surface 1204B of the same chamber is made of a stiffer material (for example, the materials used for the soft actuator shown in FIGS. 9A and 9B). The two surfaces are made of different materials with different stiffness properties so that a deformation asymmetry exists for each chamber. A liquid 1206 is filling each chamber 1204. The heating element 200 is distributed inside the plural chambers 1204 so that each chamber 1204 receives at least a block 210A of the heating element 200.

The entire soft actuator 1200 may be embedded into a first material 1220, that is expected to make the outer part of the garment. For example, the first material may be a rubber silicone, or another polymeric material. The first material 1220 is attached to a second material 1230, that makes up the garment 1202. For example, the second material 1230 may be wool or a synthetic material from which gloves or other clothing articles are made. The second material is expected to make the inner part of the garment, i.e., the part that contacts the skin of the wearer. The first material may be connected to the second material by stitching, gluing, interweaving, or any other method used in the art. In one application, the second material may be omitted and only the first material makes up the garment.

When a power source 1240 is connected to the ends of the heating element 200, the heat generated by the yarn 100 in the heating element 200 evaporates the liquid 1206, and generates the gas 1208, as shown in FIG. 12B. The gas 1208, by increasing its volume, deforms the chambers 1204. Because the top surface is more stretchable than the bottom surface of each chamber 1204, the chambers deform asymmetrically, as shown in FIG. 12B, thus modifying the surface 1222 of the first material 1220, i.e., forming crests 1222A and valleys 1222B. Thus, the roughness of the first material 1220 may be controlled with a controller 1242, which controls the electric power supplied by the power source 1240 to the heating element 200. This means that a person wearing the glove 1202, by simply adjusting the power supplied by the power source 1240, may control in effect the friction/gripping between the external surface 1220 of the glove and an object that is handled by the wearer of the glove. The surface of the garment 1202 may be changed for other reasons than changing a grip of an object.

In another embodiment, as illustrated in FIGS. 12C and 12D, the first material 1220 is omitted and the chambers 1204 are formed directly on an external surface of the second material 1230. In this way, the surface roughness of the material 1230 can be adjusted by the amount of current that is supplied by the power source 1240 to the heating element 200. In this case, the user that wears this garment directly engages the chambers 1204 with the desired object (not shown), instead of having the first material 1220 positioned between the object and the chambers.

The embodiments discussed above reveal a novel porous, flexible and high performing heating element that uses microfibers of steel. The fabricated yarn from the steel fibers is stable under electrical loading up to 2.5 A. The resistance of the yarn is almost insensitive to compressive and bending deformation. The fabricated yarn is very efficient to convert electric energy to heat energy. It could reach up to 100° C. using a very low input power of 5 W, allowing it to operate using low voltage/power equipment. The performance of the novel flexible heating element that uses this yarn is superior to the recently reported nanomaterial-based flexible heater. At the same time, the novel heating element is cheaper, safer, and can be used for both 2D and 3D heating applications. The 3D porous heating element 200 was used in one of the soft robotic applications, i.e., to obtain a large bending deformation in a limited time. This heating element can be applied to other applications where bending is necessary.

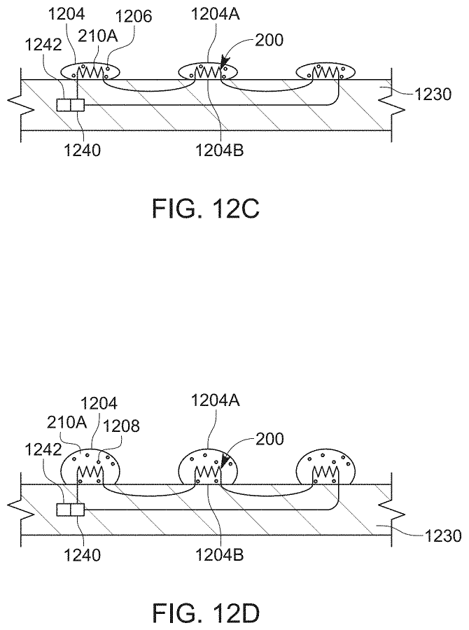

A method for changing a roughness of a surface of a garment by using the heating element 200 is now discussed with regard to FIG. 13. The method includes a step 1300 of providing an article of clothing 1202, a step 1302 of adding plural chambers 1204 filled with a liquid to the article of clothing, where the heating element extends 200 through the plural chambers 1204, and a step 1304 of applying an electrical voltage from a power source 1240, to the heating element 200, to vaporize the liquid 1206. The phase change of the liquid 1206 into the gas 1208 increases the volume of the chambers 1204, which results in a deformation of the chambers, which in fact alter the roughness of the external surface of the article of clothing.

The disclosed embodiments provide a soft actuator that is capable to bend, with little electrical power, by changing the phase of a liquid stored in the actuator. No external pressure source is used to achieve the bending of the actuator. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Aslan, M.; Kenneth, S.; Hod, L. NATURE COMMUNICATIONS 2017, 8, 596.
[2] Hong, S.; Lee, H.; Lee, J.; Kwon, J.; Han, S.; Suh, Y. D.; Cho, H.; Shin, J.; Yeo, J.; Ko, S. H. Advanced Materials 2015, 27, 4744-4751.
[3] Lee, Y.; Le, V. T.; Kim, J. G.; Kang, H.; Kim, E. S.; Ahn, S. E.; Suh, D. Advanced Functional Materials 2018, 28, 1706007.

1. A heating element comprising:
first and second blocks comprising a single piece of yarn including microfibers of steel, each block having an electrical input and an electrical output; and
an electrical connection that connects an electrical output of the first block to an electrical input of the second block,
wherein the microfibers have a diameter between 10 and 30 micrometers, and
wherein the first and second blocks extend in parallel planes, and the electrical connection extends along a line perpendicular to the parallel planes.

2. (canceled)

3. The heating element of claim 1, wherein the microfibers of steel are randomly distributed inside a yarn.

4. The heating element of claim 3, wherein the yarn has a first end that corresponds to the electrical input of the first block and has a second end that corresponds to an electrical output of the second block.

5. The heating element of claim 1, wherein the microfibers are flexible and arranged inside the blocks to form plural pores.

6. The heating element of claim 1, wherein each of the first and second blocks is made as a sponge.

7. A soft actuator comprising:
a housing having plural chambers;
a base attached to the housing to seal the chambers;
a heating element located inside the housing and extending through the plural chambers; and
a liquid filling each chamber of the plural chambers,
wherein the heating element comprises
first and second blocks comprising a single piece of yarn including microfibers of steel, each block having an electrical input and an electrical output; and
an electrical connection that connects an electrical output of the first block to an electrical input of the second block,
wherein the microfibers have a diameter between 10 and 30 micrometers, and
wherein the first and second blocks extend in parallel planes, and the electrical connection extends along a line perpendicular to the parallel planes.

8. (canceled)

9. The soft actuator of claim 7, wherein the heating element is configured to vaporize the liquid and deform the plural chambers.

10. The soft actuator of claim 7, wherein the base is less stretchable than the chambers.

11. The soft actuator of claim 10, wherein the heating element vaporizes the liquid and deforms asymmetrically the housing so that the housing bends.

12-13. (canceled)

14. The soft actuator of claim 7, wherein the microfibers of steel are randomly distributed inside a yarn.

15. The soft actuator of claim 14, wherein the yarn has a first end that corresponds to the electrical input of the first block and has a second end that corresponds to an electrical output of the second block.

16. The soft actuator of claim 7, wherein each of the first and second blocks is made as a sponge.

17. An article of clothing having an external surface with an adjustable roughness, the article of clothing comprising:
a substrate material from which the article of clothing is made; and
a soft actuator formed on the external surface of the substrate material,
wherein the soft actuator changes the roughness of the external surface of the substrate material by changing a phase of a liquid stored in the soft actuator, by using electrical energy, and
wherein the soft actuator comprises
a housing having plural chambers;
a base attached to the housing to seal the chambers;
a heating element located inside the housing and extending through the plural chambers; and
a liquid filling each chamber of the plural chambers,
wherein the heating element comprises
first and second blocks comprising a single piece of yarn including microfibers of steel, each block having an electrical input and an electrical output; and
an electrical connection that connects an electrical output of the first block to an electrical input of the second block,
wherein the microfibers have a diameter between 10 and 30 micrometers, and
wherein the first and second blocks extend in parallel planes, and the electrical connection extends along a line perpendicular to the parallel planes.

18-19. (canceled)

20. The article of clothing of claim 17, further comprising:
a layer of material formed on the substrate material, and the soft actuator is fully enclosed within the layer of material.
